(19) United States
(12) Patent Application Publication
(10) Pub. No.: US 2025/0317781 A1
(43) Pub. Date: Oct. 9, 2025

(54) CHANNEL QUALITY INDICATOR REPORTING IN RACH-LESS EARLY DATA TRANSMISSION

(71) Applicant: QUALCOMM Incorporated, San Diego, CA (US)

(72) Inventors: Bharat SHRESTHA, San Diego, CA (US); Alberto RICO ALVARINO, San Diego, CA (US); Ayan SENGUPTA, San Diego, CA (US)

(21) Appl. No.: 19/098,149

(22) Filed: Apr. 2, 2025

Related U.S. Application Data
(60) Provisional application No. 63/574,034, filed on Apr. 3, 2024.

(51) Int. Cl. H04W 24/10; H04B 7/06; H04W 72/1268; H04W 72/543

(52) U.S. Cl. CPC H04W 24/10; H04B 7/0632; H04W 72/1268; H04W 72/543

(57) ABSTRACT

Methods, systems, and devices for wireless communications are described, and more specifically for channel quality indicator (CQI) reporting in random-access-less (RACH-less) early data transmission (EDT). A user equipment (UE) may receive system information indicating that CQI reporting is enabled for an EDT procedure and indicating a carrier that is to communicate a downlink channel to the UE after transmission of a scheduled uplink transmission associated with an early data transmission. The UE may measure, in accordance with the EDT procedure, a downlink transmission on the carrier. The UE may generate a downlink CQI report based on the measurement of the downlink transmission on the carrier. The UE may transmit the scheduled uplink transmission, which includes the downlink CQI report and an early data transmission associated with the EDT procedure. The UE may monitor, based on transmitting the scheduled uplink transmission, the downlink channel for a quantity of repetitions.

### CROSS REFERENCES

This Patent Application claims the benefit of U.S. Provisional Patent Application No. 63/574,034 by SHRESTHA et al., entitled “CHANNEL QUALITY INDICATOR REPORTING IN RACH-LESS EARLY DATA TRANSMISSION,” filed Apr. 3, 2024, assigned to the assignee hereof, and expressly incorporated herein.

### FIELD OF TECHNOLOGY

The following relates to wireless communications, including channel quality indicator (CQI) reporting in RACH-less early data transmission (EDT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel quality indicator (CQI) reporting in random-access-less (RACH-less) early data transmission (EDT). For example, the described techniques provide for RACH-less EDT, where a user equipment (UE) may measure a downlink transmission on a carrier that corresponds to a downlink channel (e.g., a physical downlink control channel (PDCCH) or a physical downlink shared channel (PDSCH)) that the UE is to receive after transmission of a scheduled uplink transmission (e.g., a msg3) associated with an EDT. Based on the measurement of the downlink transmission, the UE may generate a downlink CQI report and include the report in the scheduled uplink transmission, along with data for the RACH-less EDT procedure. In some cases, the UE may receive, before measuring the downlink channel, system information (e.g., a system information block 2 (SIB2)) indicating that CQI reporting for RACH-less EDT is enabled and indicating the carrier that the UE is to measure. The UE may also determine a quantity of repetitions for the downlink channel by either 1) receiving an indication of the quantity of repetitions via the system information, 2) determining the quantity of repetitions based on the measurement of the downlink transmission on the carrier and including the quantity of repetitions in the scheduled uplink transmission, or 3) receiving the quantity of repetitions via the downlink channel on the carrier.

A method for wireless communications by a UE is described. The method may include measuring, in accordance with an EDT procedure, a downlink transmission on a carrier that is to communicate a downlink channel to the UE after transmission of a scheduled uplink transmission associated with an EDT procedure, generating a downlink channel quality report based on the measurement of the downlink transmission on the carrier, and transmitting the scheduled uplink transmission associated with the EDT procedure, where the scheduled uplink transmission includes the downlink channel quality report and an EDT for the EDT procedure.

A UE for wireless communications is described. The UE may include one or more memories storing processor executable code, and one or more processors coupled with the one or more memories. The one or more processors may individually or collectively be operable to execute the code to cause the UE to measure, in accordance with an EDT procedure, a downlink transmission on a carrier that is to communicate a downlink channel to the UE after transmission of a scheduled uplink transmission associated with an EDT procedure, generate a downlink channel quality report based on the measurement of the downlink transmission on the carrier, and transmit the scheduled uplink transmission associated with the EDT procedure, where the scheduled uplink transmission includes the downlink channel quality report and an EDT for the EDT procedure.

Another UE for wireless communications is described. The UE may include means for measuring, in accordance with an EDT procedure, a downlink transmission on a carrier that is to communicate a downlink channel to the UE after transmission of a scheduled uplink transmission associated with an EDT procedure, means for generating a downlink channel quality report based on the measurement of the downlink transmission on the carrier, and means for transmitting the scheduled uplink transmission associated with the EDT procedure, where the scheduled uplink transmission includes the downlink channel quality report and an EDT for the EDT procedure.

A non-transitory computer-readable medium storing code for wireless communications is described. The code may include instructions executable by one or more processors to measure, in accordance with an EDT procedure, a downlink transmission on a carrier that is to communicate a downlink channel to the UE after transmission of a scheduled uplink transmission associated with an EDT procedure, generate a downlink channel quality report based on the measurement of the downlink transmission on the carrier, and transmit the scheduled uplink transmission associated with the EDT procedure, where the scheduled uplink transmission includes the downlink channel quality report and an EDT for the EDT procedure.

Some examples of the method, UEs, and non-transitory computer-readable medium described herein may further include operations, features, means, or instructions for receiving, from a network entity, system information indicating the carrier, where the UE measures the downlink transmission on the carrier based on the system information.

In some examples of the method, UEs, and non-transitory computer-readable medium described herein, the system information indicates a pool of uplink shared channel resources for the EDT procedure and the carrier may be associated with a selected uplink shared channel resource of the pool of uplink shared channel resources on which the scheduled uplink transmission may be transmitted.

In some examples of the method, UEs, and non-transitory computer-readable medium described herein, receiving the system information may include operations, features, means, or instructions for receiving, via the system information, an indication that CQI reporting may be enabled for the EDT procedure, where the UE measures the downlink transmission on the carrier in accordance with the indication.

In some examples of the method, UEs, and non-transitory computer-readable medium described herein, CQI reporting for the EDT for the EDT procedure may be disabled by default.

In some examples of the method, UEs, and non-transitory computer-readable medium described herein, the system information includes an indication of a quantity of repetitions for the downlink channel and the method, apparatuses, and non-transitory computer-readable medium may include further operations, features, means, or instructions for monitoring for the downlink channel based on the quantity of repetitions indicated via the system information.

In some examples of the method, UEs, and non-transitory computer-readable medium described herein, measuring the downlink transmission on the carrier may include operations, features, means, or instructions for measuring, in accordance with the EDT procedure, the downlink transmission during a first time period prior to a second time period reserved for transmission of a preamble of a random access procedure.

In some examples of the method, UEs, and non-transitory computer-readable medium described herein, the downlink channel quality report includes an indication of a quantity of repetitions for the downlink channel that may be in accordance with the measurement of the downlink transmission on the carrier and the method, apparatuses, and non-transitory computer-readable medium may include further operations, features, means, or instructions for monitoring for the downlink channel based on the quantity of repetitions of the downlink channel quality report.

Some examples of the method, UEs, and non-transitory computer-readable medium described herein may further include operations, features, means, or instructions for receiving, after transmitting the scheduled uplink transmission, downlink control information including an indication of a quantity of repetitions of a PDSCH, where the quantity may be based on the downlink channel quality report.

Some examples of the method, UEs, and non-transitory computer-readable medium described herein may further include operations, features, means, or instructions for receiving, based on a mapping between a configuration for a quantity of downlink channel repetitions for the random access procedure and a two-bit value of the downlink channel quality report that may be a short report, a quantity of repetitions for the downlink channel and monitoring for the downlink channel based on the quantity of repetitions.

In some examples of the method, UEs, and non-transitory computer-readable medium described herein, the scheduled uplink transmission may be a message 3 of a four-step random access procedure.

In some examples of the method, UEs, and non-transitory computer-readable medium described herein, the downlink channel may be a PDCCH or a PDSCH.

In some examples of the method, UEs, and non-transitory computer-readable medium described herein, the downlink channel includes a contention resolution medium access control layer control element (MAC-CE).

In some examples of the method, UEs, and non-transitory computer-readable medium described herein, the EDT procedure may be a random access channel (RACH)-less EDT procedure and the UE measures the downlink transmission on the carrier instead of a random access response of a random access procedure in accordance with the RACH-less EDT procedure.

### BRIEF DESCRIPTION OF THE DRAWINGS

FIG. 1 shows an example of a wireless communications system that supports channel quality indicator (CQI) reporting in random-access-less (RACH-less) early data transmission (EDT) in accordance with one or more aspects of the present disclosure.

FIG. 2 shows an example of a signaling diagram that supports CQI reporting in RACH-less EDT in accordance with one or more aspects of the present disclosure.

FIG. 3 shows an example of a process flow that supports CQI reporting in RACH-less EDT in accordance with one or more aspects of the present disclosure.

FIGS. 4 and 5 show block diagrams of devices that support CQI reporting in RACH-less EDT in accordance with one or more aspects of the present disclosure.

FIG. 6 shows a block diagram of a communications manager that supports CQI reporting in RACH-less EDT in accordance with one or more aspects of the present disclosure.

FIG. 7 shows a diagram of a system including a device that supports CQI reporting in RACH-less EDT in accordance with one or more aspects of the present disclosure.

FIGS. 8 and 9 show flowcharts illustrating methods that support CQI reporting in RACH-less EDT in accordance with one or more aspects of the present disclosure.

### DETAILED DESCRIPTION

Some wireless communications systems may support an early data transmission (EDT) procedure in which a user equipment (UE) transmits data to a network entity via the message 3 (msg3) of a 4-step random access channel (RACH) procedure to reduce latency and power consumption at the UE. In a 4-step RACH procedure: first, the UE transmits a msg1 (e.g., a PRACH preamble); second, the network entity transmits a msg2 (e.g., a random access response (RAR)); third, the UE transmits a msg3 that includes a channel quality indicator (CQI) report based on the msg2 and the EDT; and fourth, the network entity transmits a msg4. Some techniques support “RACH-less EDT,” whereby a UE transmits the msg3 comprising the EDT without transmitting the preamble (msg1) and without receiving the RAR (msg2). However, because msg3 generally includes a CQI report based on measurements of msg2, the resources which the UE is to measure for transmission of the report in the RACH-less EDT may be undefined.

According to techniques described herein, for RACH-less EDT, the UE may measure a downlink transmission on a carrier that corresponds to a downlink channel (e.g., a physical downlink control channel (PDCCH) or a physical downlink shared channel (PDSCH)) that the UE is to receive after transmission of a scheduled uplink transmission (e.g., a msg3) associated with an EDT. Based on the measurement of the downlink transmission, the UE may generate a downlink CQI report and include the report in the scheduled uplink transmission, along with data for the RACH-less EDT procedure. In some cases, the UE may receive, before measuring the downlink channel, system information (e.g., a system information block 2 (SIB2)) indicating that CQI reporting for RACH-less EDT is enabled and indicating the carrier that the UE is to measure. The UE may also determine a quantity of repetitions for the downlink channel by either 1) receiving an indication of the quantity of repetitions via the system information, 2) determining the quantity of repetitions based on the measurement of the downlink transmission on the carrier and including the quantity of repetitions in the scheduled uplink transmission, or 3) receiving the quantity of repetitions via the downlink channel on the carrier.

The techniques described herein may reduce power consumption, more efficiently utilize communication resources, reduce latency, improve coordination between devices, and the techniques may lengthen battery life by clarifying, for the UE, whether to provide the downlink channel quality report and which resources to measure for the report that is to be included in a scheduled uplink transmission. As such, as the techniques described herein support EDT procedures, the techniques may result in improved utilization of communication resources and communication efficiencies.

Aspects of the disclosure are initially described in the context of wireless communications systems. Aspects of the disclosure are then described in the context of a signaling diagram and a process flow. Aspects of the disclosure are further illustrated by and described with reference to apparatus diagrams, system diagrams, and flowcharts that relate to CQI reporting in RACH-less EDT.

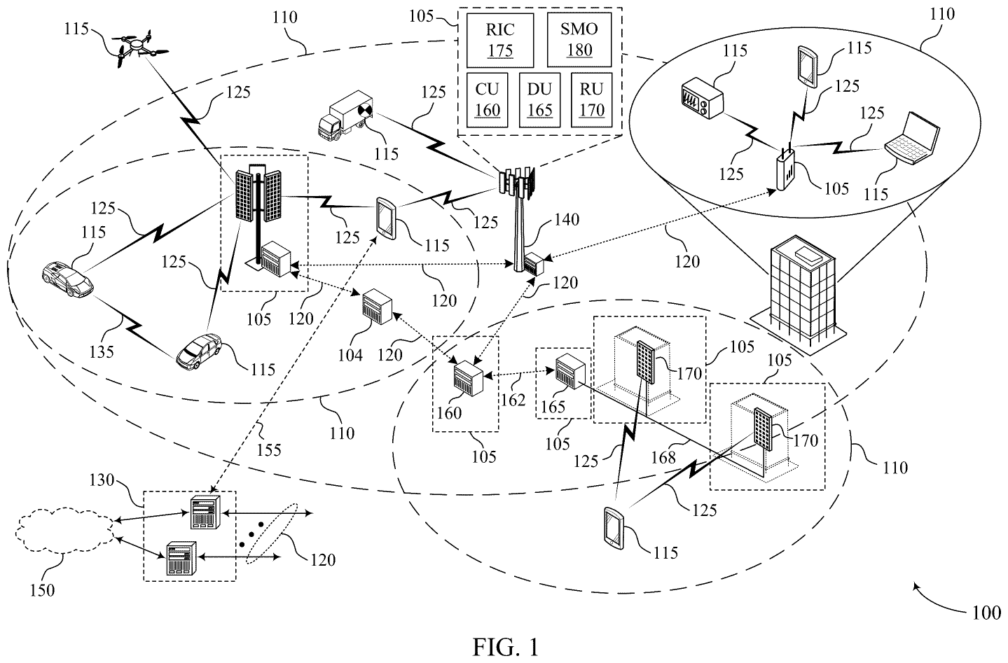

FIG. 1 shows an example of a wireless communications system 100 that supports CQI reporting in RACH-less EDT in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

For RACH-less EDT, the UE 115 may measure a downlink transmission from the network entity 105 on a carrier that corresponds to a downlink channel (e.g., PDCCH or a PDSCH) that the UE 115 is to receive after transmission of a scheduled uplink transmission (e.g., a msg3) associated with a random access procedure. Based on the measurement of the downlink transmission, the UE 115 may generate a downlink CQI report and include the report in the scheduled uplink transmission, along with data for the RACH-less EDT procedure. In some cases, the UE may receive, before measuring the downlink channel, system information (e.g., SIB2) indicating that CQI reporting for RACH-less EDT is enabled and indicating the carrier that the UE 115 is to measure. The UE 115 may also determine a quantity of repetitions for the downlink channel by either 1) receiving an indication of the quantity of repetitions via the system information, 2) determining the quantity of repetitions based on the measurement of the downlink transmission on the carrier and including the quantity of repetitions in the scheduled uplink transmission, or 3) receiving the quantity of repetitions via the downlink channel on the carrier.

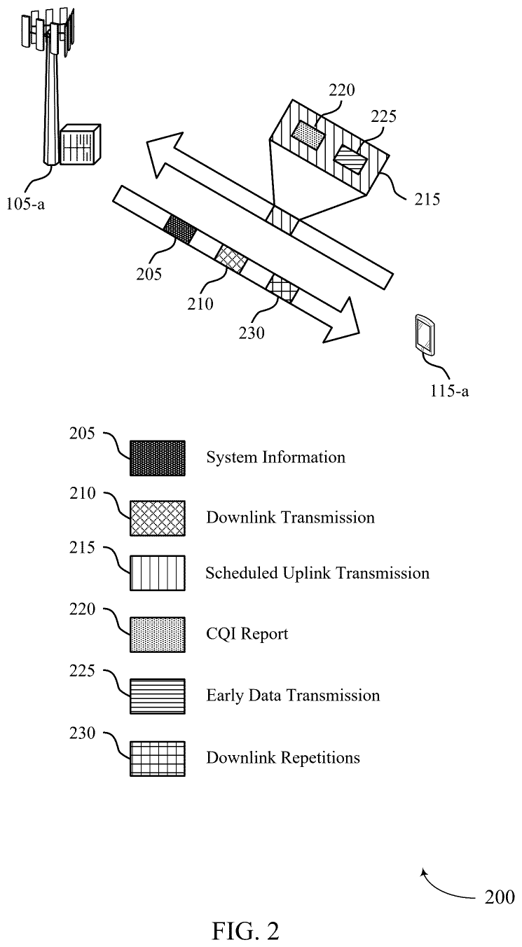

FIG. 2 shows an example of a signaling diagram 200 that supports CQI reporting in RACH-less EDT in accordance with one or more aspects of the present disclosure. In some examples, signaling diagram 200 may implement aspects of the wireless communications system 100. For example, the signaling diagram 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

Devices in the signaling diagram 200 may support an EDT procedure in which the UE 115-a may transmit data to the network entity 105-a via the msg3 of a 4-step RACH procedure to reduce latency and power consumption at the UE. In a 4-step RACH procedure: first, the UE transmits a msg1 (e.g., a PRACH preamble); second, the network entity transmits a msg2 (e.g., a RAR); third, the UE transmits a msg3 that includes a CQI report based on the msg2 and the data of the EDT; and fourth, the network entity transmits a msg4. The devices of the signaling diagram 200 may support a “RACH-less EDT,” whereby a UE transmits the msg3 comprising the EDT without transmitting the preamble (msg1) and without receiving the RAR (msg2). However, because msg3 generally includes a CQI report based on measurements of msg2 (e.g., narrowband reference signal (NRS) measurements of the carrier on which the RAR is received), it is not clear what resources the UE is to measure for transmission of the report in the RACH-less EDT. Aspects of the present disclosure discuss details for the UE 115-a to determine whether to provide the downlink CQI report and which resources to measure and include the CQI report in the msg3 for RACH-less EDT.

For example, the carrier information where downlink PDSCH or PDCCH is received in response to a scheduled uplink transmission 215 (e.g., msg3) may be provided to the UE 115-a. That is, the network entity 105-a may transmit (e.g., output), and the UE 115-a may receive (e.g., obtain), system information 205 (e.g., a SIB2) indicating that CQI reporting is enabled for RACH-less EDT (which may be disabled by default). In some examples, the system information 205 may indicate a carrier that is to communicate a downlink channel for the downlink repetitions 230 for which the UE 115-a is to monitor or receive after transmission of the scheduled uplink transmission 215. In some examples, the system information 205 may include in indication of a quantity of repetitions 230 for the downlink channel for which the UE may monitor.

In some examples, the UE 115-a may be configured to set the contents of RRCEarlyDataRequest in accordance with the RACH-less EDT procedure. For example, the UE 115-a may be a narrowband IoT UE. If the UE 115-a supports downlink channel quality reporting, cqi-Reporting is present in SystemInformationBlockType2-NB, and RACH-less EDT is initiated in accordance with a set of conditions, the UE 115-a may be configured to set the cqi-NPDCCH to include the latest results of the downlink channel quality measurements of the carrier where the UE 115-a monitors NPDCCH scheduling a downlink message with contention resolution MAC-CE is received.

For RACH EDT, cqi-Reporting in SystemInformationBlockType2-NB may be used to indicate whether the network enables the reporting in the scheduled uplink transmission 215 or not. However, this technique may be used for legacy EDT and may not be used for a RACH-less EDT procedure. In some examples, the system information 205 (e.g., the SIB2) may include an indication (e.g., an indication separate from the legacy procedure) of whether CQI reporting for RACH-less EDT is enabled or disabled. In some examples, the CQI reporting for RACH-less EDT may be disabled by default. For example, if the UE 115-a is a narrowband IoT UE, the UE 115-a supports downlink channel quality reporting, cqi-Reporting is present in SystemInformationBlockType2-NB, and cqi-ReportingRACH-lessEDT is not configured, then the UE 115-a may be configured to set the cqi-NPDCCH to include the latest results of the downlink channel quality measurements of the carrier where the RAR is received. Otherwise, if the UE 115-a supports downlink channel quality reporting and cqi-ReportingRACH-lessEDT is present in SystemInformationBlockType2-NB, then the UE 115-a may be configured to set the cqi-NPDCCH to include the latest results of the downlink channel quality measurements of the carrier where the UE 115-a monitors NPDCCH scheduling a downlink message with contention resolution MAC-CE is received.

For RACH-less EDT, a pool of uplink shared channel (UL-SCH) resources may be provided to the UE 115-a (e.g., by the network entity 105-a). That is, the system information 205 may indicate, to the UE 115-a, common preconfigured uplink resources (PUR). For each UL-SCH resource where a scheduled uplink transmission 215 is transmitted, a corresponding PDCCH carrier may exist for the UE 115-a to monitor. In some cases, the system information 205 may indicate the pool of UL-SCH resources for the EDT procedure, a pool of downlink channel resources (e.g., msg4 resources, or resources for the downlink repetitions at 335), or both. In some examples, the UE 115-b may select, from the pool of UL-SCH resources indicated by the system information 205, an uplink resource on which to transmit a scheduled uplink transmission 215. The carrier indicated by the system information 205 may be associated with the selected UL-SCH resource of the pool of UL-SCH resources.

Before initiating RACH-less EDT, the UE 115-a may perform a downlink measurement of the carrier (e.g., the carrier indicated by the system information 205). For example, the network entity 105-a may output or transmit, and the UE 115-a may receive, a downlink transmission 210 (e.g., a narrowband reference signal or another reference signal) on the carrier that is to communicate the downlink channel for the downlink repetitions 230 after transmission of the scheduled uplink transmission 215 associated with the EDT procedure. The UE 115-a may measure the channel quality of the carrier based on receiving the downlink transmission 210. In some cases, the UE 115-a may randomly choose, from the downlink resource pool indicated by the system information 205, a downlink resource to measure. The UE 115-a may measure the channel quality associated with the downlink transmission 210 based on the system information 205 indicating that CQI reporting is enabled for the EDT procedure. The measurement may be on the carrier instead of (e.g., rather than) on a RAR of a random access procedure in accordance with the EDT procedure being a RACH-less EDT procedure.

In a 4-step RACH procedure, two time periods may be defined for measurement. T1 may be defined as the period before preamble transmission (e.g., before msg1 transmission) and T2 may be defined as the period between RAR (e.g., msg2) reception and msg3 transmission. However, as there is no msg1 or msg2 for RACH-less EDT, only the period T1 may be defined or used for RACH-less EDT. For example, the UE 115-a may measure the downlink transmission 210 during the first time period T1 prior to the second time period T2 reserved for transmission of a preamble of a random access procedure.

In some examples, the UE 115-a may generate a downlink channel quality report (e.g., a downlink CQI report 220) based at least in part on the measurement of the downlink transmission 210 on the carrier. The CQI report may be a 4-bit report in CQI-NPDCCH-NB or a 2-bit short report in CQI-NPDCCH-Short-NB for RRC reestablishment. In some examples, the CQI report 220 may include an indication of a quantity of downlink repetitions 230 for the downlink channel that is in accordance with the measurement of the downlink transmission 210 on the carrier.

The UE 115-a may transmit, and the network entity 105-a may receive or obtain, the scheduled uplink transmission 215 associated with the EDT procedure. The scheduled uplink transmission 215 may include the CQI report 220 and an EDT 225 for the EDT procedure. In some examples, the scheduled uplink transmission may be (e.g., similar to, or the same as) a msg3 of a four-step random access procedure.

In some examples, the network entity 105-a may output or transmit, and the UE 115-a may receive after the transmission of the scheduled uplink transmission 215, a DCI. The DCI may include an indication of a quantity of downlink repetitions 230 of the downlink channel (e.g., PDSCH) based on the CQI report 220 transmitted via the scheduled uplink transmission 215. The downlink channel may be a PDSCH or a PDCCH and may be associated with the carrier indicated by the system information 205 and the carrier for the downlink transmission 210.

In some examples, the network entity 105-a may output or transmit, and the UE 115-a may receive (e.g., via the DCI or another transmission or message), the quantity of downlink repetitions 230 based on a mapping between a configuration for the quantity of downlink channel repetitions for the EDT procedure and a two-bit value of the CQI report 220, where the downlink channel quality report is a short report (e.g., 2 bits).

The network entity 105-a may output or transmit, and the UE 115-a may monitor for and receive (e.g., in a PDCCH monitoring window after a round trip time (RTT) offset), one or more downlink repetitions 230, which may be configured separately for msg4. The downlink repetitions 230 may be PDSCH repetitions, PDCCH repetitions, msg4 repetitions, or another type of downlink repetition. Options for the repetition level (e.g., the quantity of downlink repetitions 230) may include r1, r2, r4, r8, r16, r32, r64, r128, r256, r512, r1024, and r2048, and a repetition level update may be based on one or more of the following. In some examples, the quantity of downlink repetitions 230 may be indicated by the system information 205. For instance, if npdcch-NumRepetitionsMsg4RACH-lessEDT-r19 is configured, the UE 115-a may be configured with a channel quality measurement via a SIB (e.g., the system information 205) before initiating RACH-less EDT. For example, npdcch-NumRepetitions-RA-r14 may be configured via a SIB for msg3 and msg4 of a RACH procedure. Similarly for RACH-less EDT, npdcch-NumRepetitionsRACH-lessEDT-r19 may be configured via the system information 205. In some examples, the quantity of downlink repetitions for NPDCCH may depend on a repetition level reported by the UE 115-a in the downlink channel quality report in msg3. That is, the quantity of downlink repetitions 230 may be indicated by the CQI report 220 or based on the CQI report 220 included in the scheduled uplink transmission 215.

In some examples, the quantity of downlink repetitions 230 (e.g., repetitions of the PDSCH) may be indicated by the DCI transmitted after the transmission of the scheduled uplink transmission 215. In some examples, the quantity of downlink repetitions 230 may be based on a mapping between a configuration for a quantity of downlink channel repetitions for the EDT procedure and a two-bit value of the CQI report 220 that is a short report. For instance, for a short downlink channel quality report (e.g., CQI-NPDCCH-Short-NB with 2 bits of report), a repetition level in the report may be chosen (e.g., selected) based on the npdcch-NumRepetitions-RA-r14. Similarly, if CQI-NPDCCH-Short-NB is used for RACH-less EDT, then an existing mapping of the CQI-NPDCCH-Short-NB may depend on npdcch-NumRepetitionsRACH-lessEDT-r19.

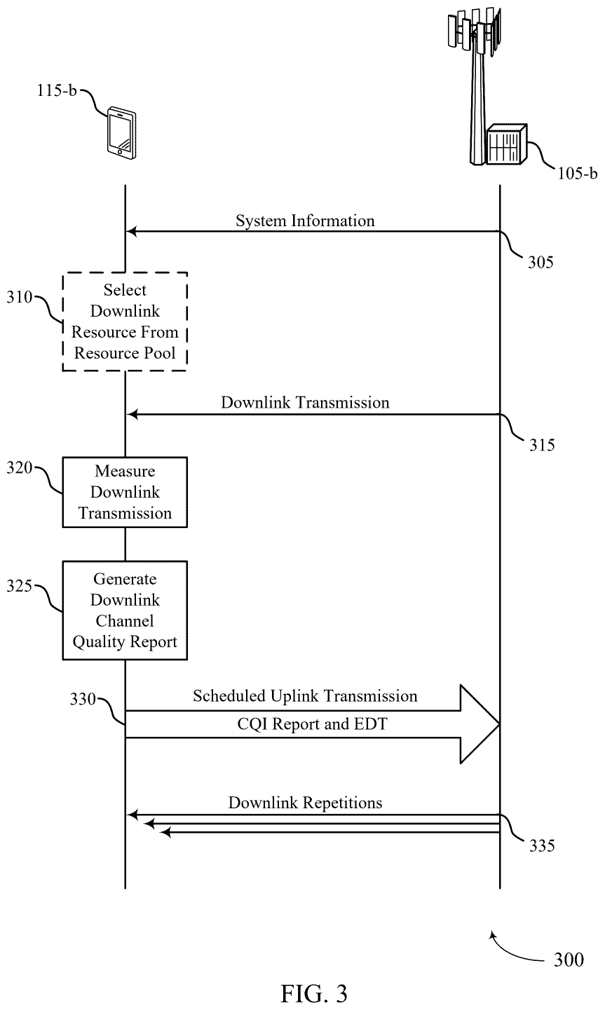

FIG. 3 shows an example of a process flow 300 that supports CQI reporting in RACH-less EDT in accordance with one or more aspects of the present disclosure. In some examples, the process flow 300 may be implemented by, or may implement aspects of, the wireless communications system 100 and the signaling diagram 200. For example, the process flow 300 includes a network entity 105-b and a UE 115-b, which may be examples of the corresponding devices described with reference to FIGS. 1 and 2. Following the process flow 300, the UE 115-b may perform a RACH-less EDT procedure with the network entity 105-b. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the network entity 105-b may output or transmit, and the UE 115-b may receive, system information (e.g., a SIB2) indicating a carrier that is to communicate a downlink channel (e.g., a PDSCH or a PDCCH that may include a contention resolution MAC-CE) to the UE 115-b after transmission (e.g., at 330) of a scheduled uplink transmission associated with an EDT. In some examples, the system information may indicate a pool of uplink shared channel resources for the EDT procedure. In some examples, the system information may indicate that CQI reporting is enabled for the EDT procedure. In some examples, CQI reporting for the EDT for the EDT procedure may be disabled by default. In some examples, the system information may include an indication of a quantity of repetitions for the downlink channel (e.g., the downlink repetitions transmitted at 335).

At 310, the UE 115-b may select, from the pool of uplink shared channel resources indicated by the system information at 305, an uplink resource on which to transmit a scheduled uplink transmission at 330. In some examples, the carrier may be associated with the selected uplink shared channel resource of the pool of uplink shared channel resources.

At 315, the network entity 105-b may output or transmit, and the UE 115-b may receive, a downlink transmission on the carrier (e.g., the carrier indicated by the system information).

At 320, the UE 115-b may measure the downlink transmission on the carrier that is to communicate the downlink channel to the UE 115-b after transmission (e.g., at 330) of the scheduled uplink transmission associated with the EDT procedure. In some examples, the measurement on the carrier may be based on the indication in the system information received at 305 that CQI reporting is enabled for the EDT procedure. In some examples, the measurement of the downlink transmission may occur during a first time period T1 prior to a second time period T2 reserved for transmission of a preamble of a random access procedure. The measurement may be on the carrier instead of (e.g., rather than) on a RAR of the random access procedure in accordance with the EDT procedure being a RACH-less EDT procedure.

At 325, the UE 115-b may generate a downlink channel quality report (e.g., a downlink CQI report) based at least in part on the measurement of the downlink transmission on the carrier at 320. In some examples, the downlink channel quality report may include an indication of a quantity of repetitions for the downlink channel that is in accordance with the measurement of the downlink transmission on the carrier at 320.

At 330, the UE 115-b may transmit, and the network entity 105-b may receive or obtain, the scheduled uplink transmission associated with the EDT procedure. The scheduled uplink transmission comprises the downlink channel quality report and an EDT for the EDT procedure. In some examples, the scheduled uplink transmission may be (e.g., similar to, or the same as) a msg3 of a four-step random access procedure. The scheduled uplink transmission at 330 may be referred to using different terminology such as an early data transmission, an uplink transmission, a msg3, an uplink scheduling information message, a PUSCH message, a RRC connection request message, or the like.

In some examples, the network entity 105-b may output or transmit, and the UE 115-b may receive after the transmission of the scheduled uplink transmission at 330, a DCI that includes an indication of a quantity of repetitions of a PDSCH (e.g., the downlink repetitions transmitted at 335) based on the downlink channel quality report generated at 325 and transmitted via the scheduled uplink transmission at 330.

In some examples, the network entity 105-b may output or transmit, and the UE 115-b may receive (e.g., via the DCI or another transmission or message), the quantity of downlink repetitions (e.g., the downlink repetitions transmitted at 335) based on a mapping between a configuration for the quantity of downlink channel repetitions for the EDT procedure and a two-bit value of the downlink channel quality report (e.g., the report generated at 320 and transmitted via the scheduled uplink transmission at 330), where the downlink channel quality report is a short report.

At 335, the network entity 105-b may output or transmit, and the UE 115-b may monitor for and receive, one or more downlink repetitions. The quantity of downlink repetitions may be determined in one or more of several techniques. For example, the quantity of downlink repetitions may be indicated by the system information transmitted at 305. In some examples, the quantity of downlink repetitions may be indicated by the downlink channel quality report generated at 325 and transmitted via the scheduled uplink transmission at 330. In some examples, the quantity of downlink repetitions may be indicated by the DCI transmitted after the transmission of the scheduled uplink transmission at 330. In some examples, the quantity of downlink repetitions may be based on a mapping between a configuration for a quantity of downlink channel repetitions for the EDT procedure and a two-bit value of the downlink channel quality report that is a short report. In some cases, the quantity of PDCCH repetitions at 335 may be based on the CQI report, based on the system information, or based on the mapping. In such cases, the quantity of PDSCH repetitions may be based on these method or may be configured via the DCI included in the PDCCH repetitions.

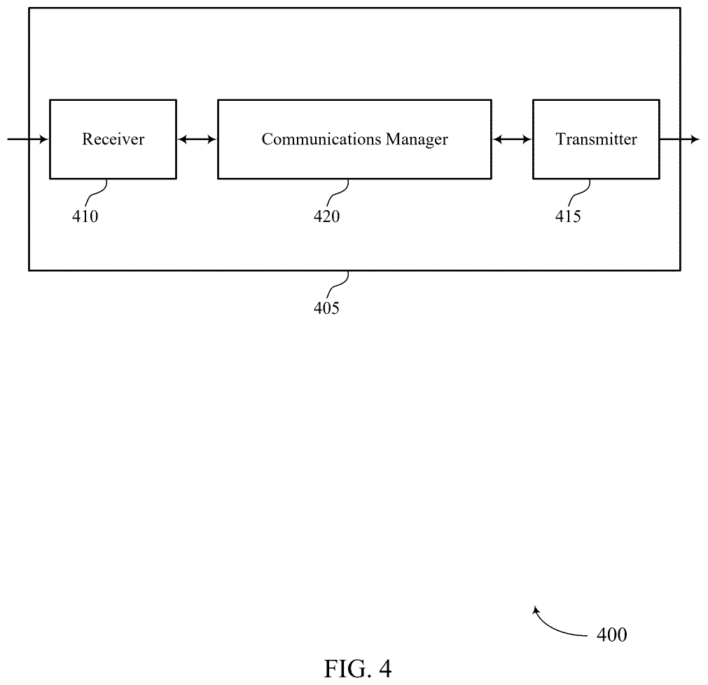

FIG. 4 shows a block diagram 400 of a device 405 that supports CQI reporting in RACH-less EDT in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to CQI reporting in RACH-less EDT). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to CQI reporting in RACH-less EDT). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of CQI reporting in RACH-less EDT as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for measuring, in accordance with an EDT procedure, a downlink transmission on a carrier that is to communicate a downlink channel to the UE after transmission of a scheduled uplink transmission associated with an EDT. The communications manager 420 is capable of, configured to, or operable to support a means for generating a downlink channel quality report based on the measurement of the downlink transmission on the carrier. The communications manager 420 is capable of, configured to, or operable to support a means for transmitting the scheduled uplink transmission associated with the EDT procedure, where the scheduled uplink transmission includes the downlink channel quality report and an EDT for the EDT procedure.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

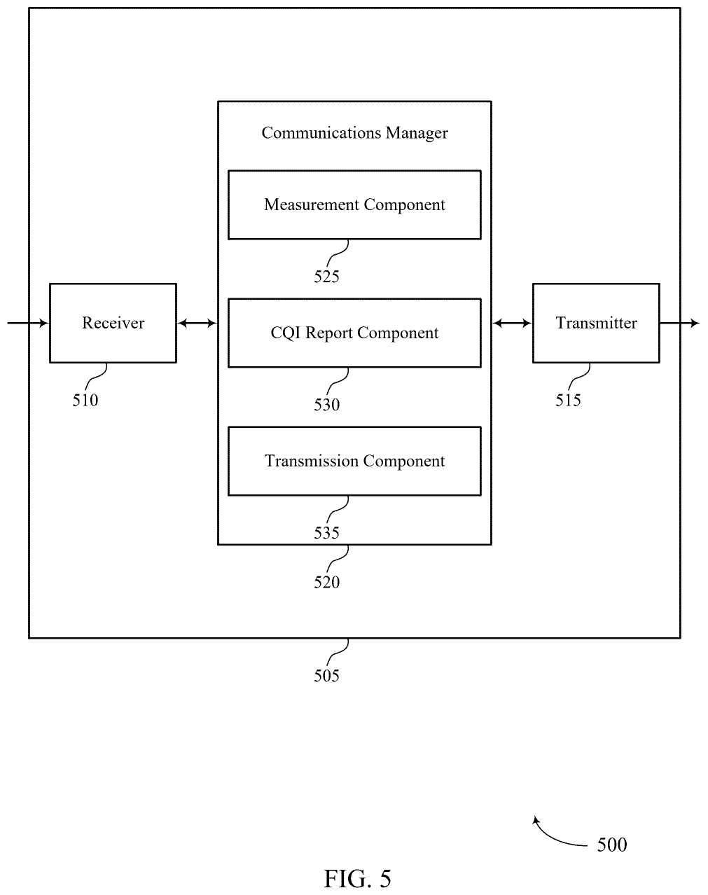

FIG. 5 shows a block diagram 500 of a device 505 that supports CQI reporting in RACH-less EDT in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to CQI reporting in RACH-less EDT). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CQI reporting in RACH-less EDT). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of CQI reporting in RACH-less EDT as described herein. For example, the communications manager 520 may include a measurement component 525, a CQI report component 530, a transmission component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The measurement component 525 is capable of, configured to, or operable to support a means for measuring, in accordance with an EDT procedure, a downlink transmission on a carrier that is to communicate a downlink channel to the UE after transmission of a scheduled uplink transmission associated with an EDT. The CQI report component 530 is capable of, configured to, or operable to support a means for generating a downlink channel quality report based on the measurement of the downlink transmission on the carrier. The transmission component 535 is capable of, configured to, or operable to support a means for transmitting the scheduled uplink transmission associated with the EDT procedure, where the scheduled uplink transmission includes the downlink channel quality report and an EDT for the EDT procedure.

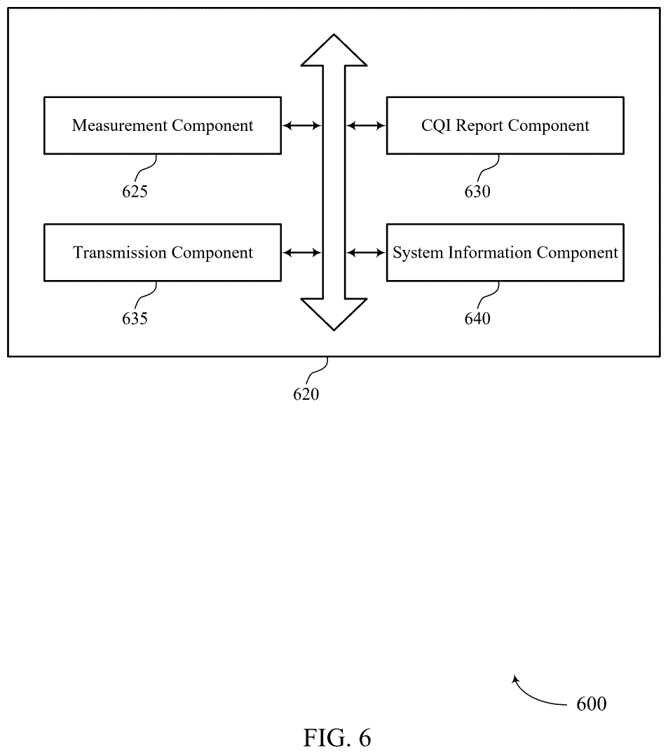

FIG. 6 shows a block diagram 600 of a communications manager 620 that supports CQI reporting in RACH-less EDT in accordance with one or more aspects of the present disclosure. The communications manager 620 may be an example of aspects of a communications manager 420, a communications manager 520, or both, as described herein. The communications manager 620, or various components thereof, may be an example of means for performing various aspects of CQI reporting in RACH-less EDT as described herein. For example, the communications manager 620 may include a measurement component 625, a CQI report component 630, a transmission component 635, a system information component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The measurement component 625 is capable of, configured to, or operable to support a means for measuring, in accordance with an EDT procedure, a downlink transmission on a carrier that is to communicate a downlink channel to the UE after transmission of a scheduled uplink transmission associated with an EDT. The CQI report component 630 is capable of, configured to, or operable to support a means for generating a downlink channel quality report based on the measurement of the downlink transmission on the carrier. The transmission component 635 is capable of, configured to, or operable to support a means for transmitting the scheduled uplink transmission associated with the EDT procedure, where the scheduled uplink transmission includes the downlink channel quality report and an EDT for the EDT procedure.

In some examples, the system information component 640 is capable of, configured to, or operable to support a means for receiving, from a network entity, system information indicating the carrier, where the UE measures the downlink transmission on the carrier based on the system information.

In some examples, the system information indicates a pool of uplink shared channel resources for the EDT procedure and, in some examples, the carrier is associated with a selected uplink shared channel resource of the pool of uplink shared channel resources on which the scheduled uplink transmission is transmitted.

In some examples, to support receiving the system information, the system information component 640 is capable of, configured to, or operable to support a means for receiving, via the system information, an indication that CQI (CQI) reporting is enabled for the EDT procedure, where the UE measures the downlink transmission on the carrier in accordance with the indication.

In some examples, CQI reporting for the EDT for the EDT procedure is disabled by default.

In some examples, the system information includes an indication of a quantity of repetitions for the downlink channel, and the system information component 640 is capable of, configured to, or operable to support a means for monitoring for the downlink channel based on the quantity of repetitions indicated via the system information.

In some examples, to support measuring the downlink transmission on the carrier, the measurement component 625 is capable of, configured to, or operable to support a means for measuring, in accordance with the EDT procedure, the downlink transmission during a first time period prior to a second time period reserved for transmission of a preamble of a random access procedure.

In some examples, the downlink channel quality report includes an indication of a quantity of repetitions for the downlink channel that is in accordance with the measurement of the downlink transmission on the carrier, and the CQI report component 630 is capable of, configured to, or operable to support a means for monitoring for the downlink channel based on the quantity of repetitions of the downlink channel quality report.

In some examples, the CQI report component 630 is capable of, configured to, or operable to support a means for receiving, after transmitting the scheduled uplink transmission, downlink control information including an indication of a quantity of repetitions of a PDSCH, where the quantity is based on the downlink channel quality report.

In some examples, the CQI report component 630 is capable of, configured to, or operable to support a means for receiving, based on a mapping between a configuration for a quantity of downlink channel repetitions for the EDT procedure and a two-bit value of the downlink channel quality report that is a short report, a quantity of repetitions for the downlink channel. In some examples, the CQI report component 630 is capable of, configured to, or operable to support a means for monitoring for the downlink channel based on the quantity of repetitions.

In some examples, the scheduled uplink transmission is a message 3 of a four-step random access procedure.

In some examples, the downlink channel is a PDCCH or an PDSCH.

In some examples, the downlink channel includes a contention resolution medium access control layer control element (MAC-CE).

In some examples, the EDT procedure is a RACH-less EDT procedure and, in some examples, the UE measures the downlink transmission on the carrier instead of a RAR of a random access procedure in accordance with the RACH-less EDT procedure.

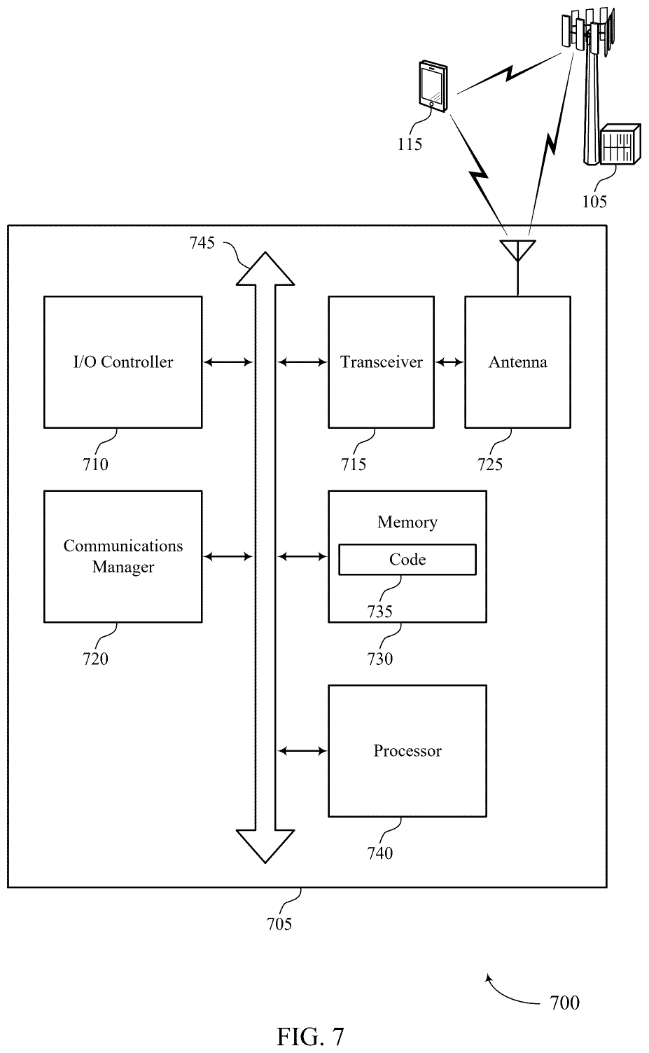

FIG. 7 shows a diagram of a system 700 including a device 705 that supports CQI reporting in RACH-less EDT in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting CQI reporting in RACH-less EDT). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for measuring, in accordance with an EDT procedure, a downlink transmission on a carrier that is to communicate a downlink channel to the UE after transmission of a scheduled uplink transmission associated with an EDT. The communications manager 720 is capable of, configured to, or operable to support a means for generating a downlink channel quality report based on the measurement of the downlink transmission on the carrier. The communications manager 720 is capable of, configured to, or operable to support a means for transmitting the scheduled uplink transmission associated with the EDT procedure, where the scheduled uplink transmission includes the downlink channel quality report and an EDT for the EDT procedure.

By including or configuring the communications manager 720 in accordance with examples as described herein, the device 705 may support techniques for reduced latency, reduced power consumption, more efficient utilization of communication resources, improved coordination between devices, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of CQI reporting in RACH-less EDT as described herein, or the at least one processor 740 and the at least one memory 730 may be otherwise configured to, individually or collectively, perform or support such operations.

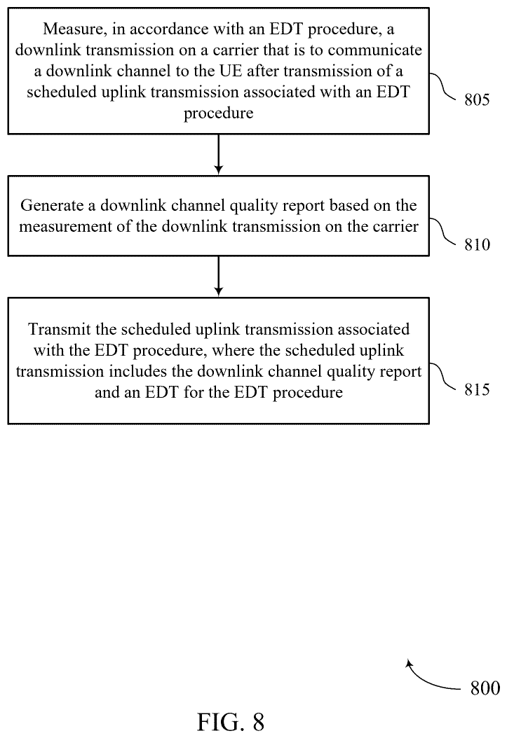

FIG. 8 shows a flowchart illustrating a method 800 that supports CQI reporting in RACH-less EDT in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include measuring, in accordance with an EDT procedure, a downlink transmission on a carrier that is to communicate a downlink channel to the UE after transmission of a scheduled uplink transmission associated with an EDT. The operations of 805 may be performed in accordance with examples as disclosed herein. In some examples, aspects of the operations of 805 may be performed by a measurement component 625 as described with reference to FIG. 6.

At 810, the method may include generating a downlink channel quality report based on the measurement of the downlink transmission on the carrier. The operations of 810 may be performed in accordance with examples as disclosed herein. In some examples, aspects of the operations of 810 may be performed by a CQI report component 630 as described with reference to FIG. 6.

At 815, the method may include transmitting the scheduled uplink transmission associated with the EDT procedure, where the scheduled uplink transmission includes the downlink channel quality report and an EDT for the EDT procedure. The operations of 815 may be performed in accordance with examples as disclosed herein. In some examples, aspects of the operations of 815 may be performed by a transmission component 635 as described with reference to FIG. 6.

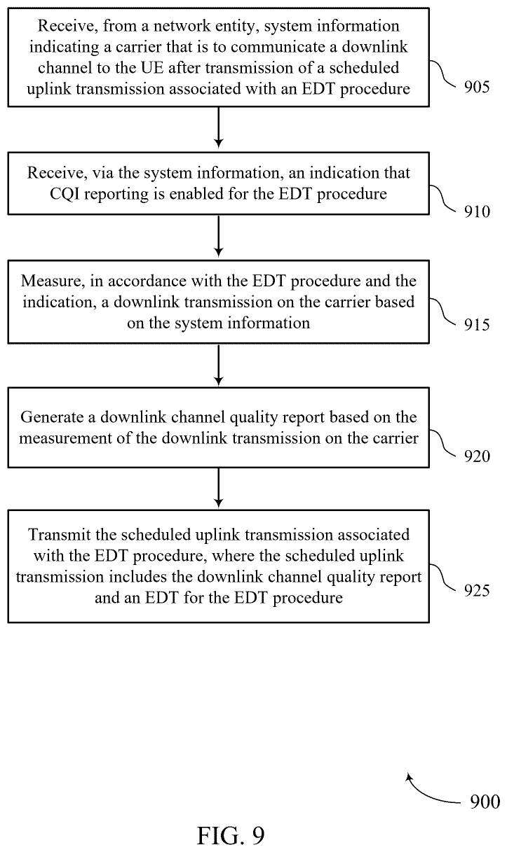

FIG. 9 shows a flowchart illustrating a method 900 that supports CQI reporting in RACH-less EDT in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving, from a network entity, system information indicating the carrier, where the UE measures the downlink transmission on the carrier based on the system information. The operations of 905 may be performed in accordance with examples as disclosed herein. In some examples, aspects of the operations of 905 may be performed by a system information component 640 as described with reference to FIG. 6.

At 910, the method may include receiving, via the system information, an indication that CQI (CQI) reporting is enabled for the EDT procedure, where the UE measures the downlink transmission on the carrier in accordance with the indication. The operations of 910 may be performed in accordance with examples as disclosed herein. In some examples, aspects of the operations of 910 may be performed by a system information component 640 as described with reference to FIG. 6.

At 915, the method may include measuring, in accordance with an EDT procedure, a downlink transmission on a carrier that is to communicate a downlink channel to the UE after transmission of a scheduled uplink transmission associated with an EDT. The operations of 915 may be performed in accordance with examples as disclosed herein. In some examples, aspects of the operations of 915 may be performed by a measurement component 625 as described with reference to FIG. 6.

At 920, the method may include generating a downlink channel quality report based on the measurement of the downlink transmission on the carrier. The operations of 920 may be performed in accordance with examples as disclosed herein. In some examples, aspects of the operations of 920 may be performed by a CQI report component 630 as described with reference to FIG. 6.

At 925, the method may include transmitting the scheduled uplink transmission associated with the EDT procedure, where the scheduled uplink transmission includes the downlink channel quality report and an EDT for the EDT procedure. The operations of 925 may be performed in accordance with examples as disclosed herein. In some examples, aspects of the operations of 925 may be performed by a transmission component 635 as described with reference to FIG. 6.

The following provides an overview of aspects of the present disclosure:

Aspect 1: A method for wireless communications at a UE, comprising: measuring, in accordance with an early data transmission procedure, a downlink transmission on a carrier that is to communicate a downlink channel to the UE after transmission of a scheduled uplink transmission associated with an early data transmission procedure; generating a downlink channel quality report based at least in part on the measurement of the downlink transmission on the carrier; and transmitting the scheduled uplink transmission associated with the early data transmission procedure, wherein the scheduled uplink transmission comprises the downlink channel quality report and an early data transmission for the early data transmission procedure.

Aspect 2: The method of aspect 1, further comprising: receiving, from a network entity, system information indicating the carrier, wherein the UE measures the downlink transmission on the carrier based at least in part on the system information.

Aspect 3: The method of aspect 2, wherein the system information indicates a pool of uplink shared channel resources for the early data transmission procedure and the carrier is associated with a selected uplink shared channel resource of the pool of uplink shared channel resources on which the scheduled uplink transmission is transmitted.

Aspect 4: The method of any of aspects 2 through 3, wherein receiving the system information comprises: receiving, via the system information, an indication that channel quality indicator (CQI) reporting is enabled for the early data transmission procedure, wherein the UE measures the downlink transmission on the carrier in accordance with the indication.

Aspect 5: The method of aspect 4, wherein CQI reporting for the early data transmission for the early data transmission procedure is disabled by default.

Aspect 6: The method of any of aspects 2 through 5, wherein the system information comprises an indication of a quantity of repetitions for the downlink channel, the method further comprising: monitoring for the downlink channel based at least in part on the quantity of repetitions indicated via the system information.

Aspect 7: The method of any of aspects 1 through 6, wherein measuring the downlink transmission on the carrier comprises: measuring, in accordance with the early data transmission procedure, the downlink transmission during a first time period prior to a second time period reserved for transmission of a preamble of a random access procedure.

Aspect 8: The method of any of aspects 1 through 7, wherein the downlink channel quality report comprises an indication of a quantity of repetitions for the downlink channel that is in accordance with the measurement of the downlink transmission on the carrier, the method further comprising: monitoring for the downlink channel based at least in part on the quantity of repetitions of the downlink channel quality report.

Aspect 9: The method of any of aspects 1 through 8, further comprising: receiving, after transmitting the scheduled uplink transmission, downlink control information comprising an indication of a quantity of repetitions of a physical downlink shared channel, wherein the quantity is based at least in part on the downlink channel quality report.

Aspect 10: The method of any of aspects 1 through 9, further comprising: receiving, based at least in part on a mapping between a configuration for a quantity of downlink channel repetitions for the random access procedure and a two-bit value of the downlink channel quality report that is a short report, a quantity of repetitions for the downlink channel; and monitoring for the downlink channel based at least in part on the quantity of repetitions.

Aspect 11: The method of any of aspects 1 through 10, wherein the scheduled uplink transmission is a message 3 of a four-step random access procedure.

Aspect 12: The method of any of aspects 1 through 11, wherein the downlink channel is a PDCCH or an PDSCH.

Aspect 13: The method of any of aspects 1 through 12, wherein the downlink channel comprises a contention resolution medium access control layer control element (MAC-CE).

Aspect 14: The method of any of aspects 1 through 13, wherein the early data transmission procedure is a RACH-less early data transmission procedure and the UE measures the downlink transmission on the carrier instead of a random access response of a random access procedure in accordance with the RACH-less early data transmission procedure.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
measure, in accordance with an early data transmission procedure, a downlink transmission on a carrier that is to communicate a downlink channel to the UE after transmission of a scheduled uplink transmission associated with the early data transmission procedure;
generate a downlink channel quality report based at least in part on the measurement of the downlink transmission on the carrier; and
transmit the scheduled uplink transmission associated with the early data transmission procedure, wherein the scheduled uplink transmission comprises the downlink channel quality report and an early data transmission for the early data transmission procedure.

2. The UE of claim 1, wherein the one or more processors are individually or collectively further operable to execute the code to cause the UE to:
receive, from a network entity, system information indicating the carrier, wherein the UE measures the downlink transmission on the carrier based at least in part on the system information.

3. The UE of claim 2, wherein:
the system information indicates a pool of uplink shared channel resources for the early data transmission procedure; and
the carrier is associated with a selected uplink shared channel resource of the pool of uplink shared channel resources on which the scheduled uplink transmission is transmitted.

4. The UE of claim 2, wherein, to receive the system information, the one or more processors are individually or collectively operable to execute the code to cause the UE to:
receive, via the system information, an indication that channel quality indicator (CQI) reporting is enabled for the early data transmission procedure, wherein the UE measures the downlink transmission on the carrier in accordance with the indication.

5. The UE of claim 4, wherein CQI reporting for the early data transmission for the early data transmission procedure is disabled by default.

6. The UE of claim 2, wherein the system information comprises an indication of a quantity of repetitions for the downlink channel, and the one or more processors are individually or collectively further operable to execute the code to cause the UE to:
monitor for the downlink channel based at least in part on the quantity of repetitions indicated via the system information.

7. The UE of claim 1, wherein, to measure the downlink transmission on the carrier, the one or more processors are individually or collectively operable to execute the code to cause the UE to:
measure, in accordance with the early data transmission procedure, the downlink transmission during a first time period prior to a second time period reserved for transmission of a preamble of a random access procedure.

8. The UE of claim 1, wherein the downlink channel quality report comprises an indication of a quantity of repetitions for the downlink channel that is in accordance with the measurement of the downlink transmission on the carrier, and the one or more processors are individually or collectively further operable to execute the code to cause the UE to:
monitor for the downlink channel based at least in part on the quantity of repetitions of the downlink channel quality report.

9. The UE of claim 1, wherein the one or more processors are individually or collectively further operable to execute the code to cause the UE to:
receive, after transmitting the scheduled uplink transmission, downlink control information comprising an indication of a quantity of repetitions of a physical downlink shared channel, wherein the quantity is based at least in part on the downlink channel quality report.

10. The UE of claim 1, wherein the one or more processors are individually or collectively further operable to execute the code to cause the UE to:
receive, based at least in part on a mapping between a configuration for a quantity of downlink channel repetitions for the early data transmission procedure and a two-bit value of the downlink channel quality report that is a short report, a quantity of repetitions for the downlink channel; and
monitor for the downlink channel based at least in part on the quantity of repetitions.

11. The UE of claim 1, wherein the scheduled uplink transmission is a message 3 of a four-step random access procedure.

12. The UE of claim 1, wherein the downlink channel is a physical downlink control channel (PDCCH) or a physical downlink shared channel (PDSCH).

13. The UE of claim 1, wherein the downlink channel comprises a contention resolution medium access control layer control element (MAC-CE).

14. The UE of claim 1, wherein:
the early data transmission procedure is a RACH-less early data transmission procedure; and
the UE measures the downlink transmission on the carrier instead of a random access response of a random access procedure in accordance with the RACH-less early data transmission procedure.

15. A method for wireless communications at a user equipment (UE), comprising:
measuring, in accordance with an early data transmission procedure, a downlink transmission on a carrier that is to communicate a downlink channel to the UE after transmission of a scheduled uplink transmission associated with an early data transmission procedure;
generating a downlink channel quality report based at least in part on the measurement of the downlink transmission on the carrier; and
transmitting the scheduled uplink transmission associated with the early data transmission procedure, wherein the scheduled uplink transmission comprises the downlink channel quality report and an early data transmission for the early data transmission procedure.

16. The method of claim 15, further comprising:
receiving, from a network entity, system information indicating the carrier, wherein the UE measures the downlink transmission on the carrier based at least in part on the system information.

17. The method of claim 16, wherein:
the system information indicates a pool of uplink shared channel resources for the early data transmission procedure; and
the carrier is associated with a selected uplink shared channel resource of the pool of uplink shared channel resources on which the scheduled uplink transmission is transmitted.

18. The method of claim 16, wherein receiving the system information comprises:
receiving, via the system information, an indication that channel quality indicator (CQI) reporting is enabled for the early data transmission procedure, wherein the UE measures the downlink transmission on the carrier in accordance with the indication.

19. The method of claim 18, wherein CQI reporting for the early data transmission for the early data transmission procedure is disabled by default.

20. A user equipment (UE) for wireless communications, comprising:
means for measuring, in accordance with an early data transmission procedure, a downlink transmission on a carrier that is to communicate a downlink channel to the UE after transmission of a scheduled uplink transmission associated with the early data transmission procedure;
means for generating a downlink channel quality report based at least in part on the measurement of the downlink transmission on the carrier; and
means for transmitting the scheduled uplink transmission associated with the early data transmission procedure, wherein the scheduled uplink transmission comprises the downlink channel quality report and an early data transmission for the early data transmission procedure.
